(19) United States
(12) Patent Application Publication
(10) Pub. No.: US 2018/0139331 A1
(43) Pub. Date: May 17, 2018

(54) AUXILIARY RADIO COMMUNICATIONS SYSTEM WITH INTEGRATED DISPATCH CONSOLE

(71) Applicant: Pinnacle Wireless USA, Inc., Fair Lawn, NJ (US)

(72) Inventors: Steven R. Ahmed, Farmingville, NY (US); Richard Kropp, Central Islip, NY (US)

(21) Appl. No.: 15/350,989

(22) Filed: Nov. 14, 2016

(51) Int. Cl. H04M 11/04; H04B 7/04; H04M 7/00; H04M 1/02; G08B 21/18; H04M 1/21; H04M 1/23; H04B 1/40; H02J 9/06; H02J 7/02

(52) U.S. Cl. CPC H04M 11/04; H04B 7/04; H04M 7/0069; H04M 1/0297; G08B 21/182; H04W 88/085; H04M 1/236; H04B 1/40; H02J 9/061; H02J 7/022; H04M 1/21

(57) ABSTRACT

Embodiments provide an auxiliary radio communications system with an integrated dispatch console. The system can have at least one deskset; at least one AC power supply, wherein the AC power supply supplies power to the at least one deskset and at least one battery backup; a physical wire input/output board connected to at least one base station; and a programmable logic circuit, wherein the programmable logic circuit controls the interaction of the deskset and the physical wire input/output board. Multiple redundant AC circuits can be used. The communications system can communicate with one or more base stations, either via physical wires and/or through wireless communication means. Redundant communications systems can ensure that communication is not interrupted in the event of an emergency.

### TECHNICAL FIELD

The present application relates generally to a system for auxiliary radio communication in multi-story buildings for use by first response teams.

### BACKGROUND

Auxiliary Radio Communications Systems (ARCS) are presently a New York Fire Department requirement in all new buildings above 75 feet and all buildings being refurbished. Individual building requirements vary based on the size of the building and the level of back-up requested in the building specification. Several versions of ARCS are on the market providing limited capabilities and fixed packages. The purpose of this invention is to enhance the capabilities for the fire department personnel on-site. The flexibility of the Auxiliary Radio Communications System with Integrated Dispatch Console (ARCS-IDC) allows it to cover almost any requirement the building may have in the near term and allow for future upgrades without a total replacement.

### SUMMARY

Embodiments can provide an auxiliary radio communications system with an integrated dispatch console, comprising at least one deskset; at least one AC power supply, wherein the AC power supply supplies power to the at least one deskset and at least one battery backup; a physical wire input/output board connected to at least one base station; and a programmable logic circuit, wherein the programmable logic circuit controls the interaction of the deskset and the physical wire input/output board.

Embodiments can further provide a system further comprising at least one audio accessory box capable of telephony communication connection.

Embodiments can further provide a system wherein the audio accessory box provides a plain old telephone service connection.

Embodiments can further provide a system further comprising at least one extended panel audio interface connected to each audio accessory box.

Embodiments can further provide a system wherein each extended panel audio interface has at least one additional communication device attached.

Embodiments can further provide a system further comprising a distributed antenna system to communicate with the base stations using at least one wireless communication protocol.

Embodiments can further provide a system wherein the programmable logic circuit is configured to activate an alarm in the event the battery backup is low.

Embodiments can further provide a system further comprising one or more key switches to control functionality of the integrated dispatch console.

Embodiments can further provide a system further comprising at least one DC/DC converter connected to each AC power supply.

Embodiments can further provide a system wherein the at least one AC power supply derives power from a plurality of AC circuits.

Embodiments can further provide an auxiliary radio communications system with an integrated dispatch console, comprising a first deskset; a second deskset; a first AC power supply connected to a first battery backup; a second AC power supply connected to a second battery backup; a physical wire input/output board connected to at least one base station; and a programmable logic circuit, wherein the programmable logic circuit controls the interaction of the desksets and the physical wire input/output board.

Embodiments can further provide a system further comprising a first audio accessory box connected to the first deskset; and a second audio accessory box connected to the second deskset; wherein each audio accessory box is capable of telephony communication connection.

Embodiments can further provide a system wherein each audio accessory box provides a plain old telephone service connection.

Embodiments can further provide a system further comprising a first extended panel audio interface connected to the first audio accessory box; and a second extended panel audio interface connected to the second audio accessory box.

Embodiments can further provide a system wherein each extended panel audio interface has at least one additional communication device attached.

Embodiments can further provide a system further comprising a distributed antenna system to communicate with the base stations using at least one wireless communication protocol.

Embodiments can further provide a system further comprising one or more key switches; wherein the one or more key switches control whether the first or the second deskset is used and to what base station the deskset connects.

Embodiments can further provide a system further comprising a first DC/DC converter connected to the first AC power supply; and a second DC/DC converter connected to the second AC power supply.

Embodiments can further provide a system wherein the first AC power supply derives power from a first AC circuit; and the second AC power supply derives power from a second AC circuit.

Embodiments can further provide an auxiliary radio communications system, comprising at least one base station; and an integrated dispatch console, comprising at least one deskset; a recording module configured to record communications passing through the at least one deskset; at least one AC power supply, wherein the AC power supply supplies power to the at least one deskset and at least one battery backup; a physical wire input/output board connected to the at least one base station; and a programmable logic circuit, wherein the programmable logic circuit controls the interaction of the deskset and the physical wire input/output board; and wherein the programmable logic circuit controls one or more alarms.

Additional features and advantages of this disclosure will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 depicts a block diagram of the power circuitry of an Auxiliary Radio Communications System with Integrated Dispatch Console (ARCS-IDS), according to embodiments described herein;

FIG. 2 depicts a block diagram of the audio and control circuitry of an Auxiliary Radio Communications System with Integrated Dispatch Console (ARCS-IDS), according to embodiments described herein;

FIG. 3 depicts the connectional functionality of an Auxiliary Radio Communications System with Integrated Dispatch Console (ARCS-IDS) when incorporated into a general emergency communication system, in accordance with embodiments described herein;

FIG. 4 illustrates a desk-based Auxiliary Radio Communications System with Integrated Dispatch Console (ARCS-IDS), according to embodiments described herein;

FIG. 5 illustrates a wall-mounted Auxiliary Radio Communications System with Integrated Dispatch Console (ARCS-IDS), according to embodiments described herein;

FIG. 6 illustrates a ceiling-mounted Auxiliary Radio Communications System with Integrated Dispatch Console (ARCS-IDS), according to embodiments described herein; and

FIG. 7 illustrates two wall-mounted Auxiliary Radio Communications Systems with Integrated Dispatch Console (ARCS-IDS), according to embodiments described herein.

### DETAILED DESCRIPTION OF EXEMPLARY EMBODIMENTS

The Auxiliary Radio Communications System with Integrated Dispatch Console (ARCS-IDS) can be implemented to enhance the capabilities of firefighters and other first responders, and can provide greater back-up options as well as alarm & control to insure an emergency communication system is available when needed. Redundancy is used as much as possible within the ARCS-IDC, and the ARCS-IDC is capable of controlling external redundant system designs.

According to embodiments described herein, key features of the ARCS-IDS include the ability to control multiple base stations, the ability to combine repeater and Simplex HT-Channels in one console, a programmable logic circuit-based alarm and control system which can be flexible and able to provide additional outputs to a general fire command station, accept additional inputs for more complete system monitoring, provide AC power redundancy, internal DC power redundancy, provide available single or dual internal uninterruptible power supplies with external batteries, the ability to accept a plain old telephone service (POTS) telephone line, and provide instant recall of communication recordings.

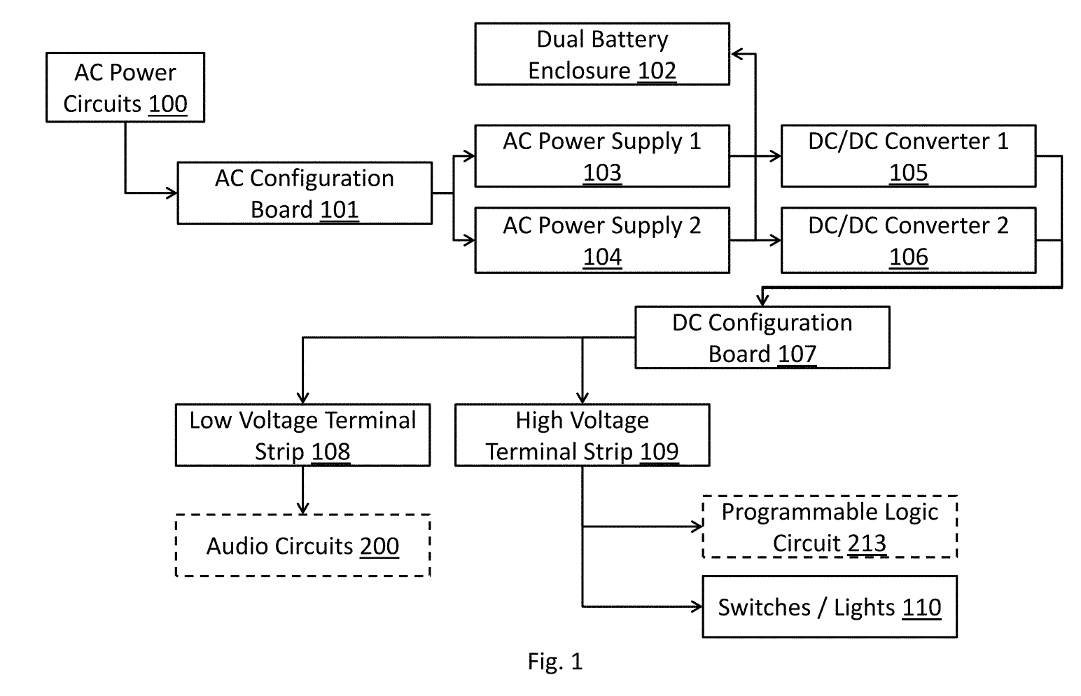

FIG. 1 depicts a block diagram of the power circuitry of an Auxiliary Radio Communications System with Integrated Dispatch Console (ARCS-IDS), according to embodiments described herein. One or more AC circuits 100 can be connected to an AC configuration board 101. The AC configuration board 101 can configure the AC power input for the one or more AC circuits 100. In an embodiment, jumpers can be used for the configuration. In an embodiment only having a single AC circuit 100, both internal power supplies (discussed below), can share the same AC circuit 100. In order to increase redundancy, two or more independent AC circuits 100 are recommended in order to prevent against power loss, power surges, or unexpected power blow outs. In the event of a power failure of one AC circuit 100, the AC configuration board 101 would enable the secondary AC circuit 100 to power the ARCS-IDS.

The AC configuration board 101 can route the power of the AC circuits 100 into one or more AC power supplies. In an embodiment, the ARCS-IDS can have a first AC power supply 103 and a second AC power supply 104. Each of the two AC power supplies 103, 104 can be dual output, with one output being connected to the rest of the power circuitry of the ARCS-IDS, while the other output can be used to charge a battery backup, which can be located in a dual source battery enclosure 102. In an embodiment, one or both of the AC power supplies can be 12 volts. In the event of a failure of one or more of the AC circuits 100, the AC power supplies can be configured to switch seamlessly to a battery back-up. The presence of more than one AC power supply and more than one backup battery ensures redundancy. Establishing the backup can be dependent on the type and location of the batteries used for backup. In an embodiment, the batteries can be located in close proximity to the main console to ensure rapid backup of the system. In an embodiment, the AC power supplies can activate an alarm in the event of a power failure, as well as in the event of low charge in one or more of the backup batteries. The programmable logic circuit (PLC) can monitor battery level.

Each of the one or more AC power supplies can independently feed into a DC/DC converter. In an embodiment, the first AC power supply 103 can be connected to a first DC/DC converter 105, while the second AC power supply 104 can be connected to a second DC/DC converter. The DC/DC converters can be used to convert the AC current into a DC voltage for use in the electronic components of the ARCS-IDS. In an embodiment, the output voltage can be 5, 12, or 24 volts. As with the multiple AC circuits and AC power supplies, having multiple DC/DC converters connected to independent power supplies provides DC power redundancy in the event of a power loss of one or more of the AC circuits 100.

Each of the one or more DC/DC converters can be connected to a DC configuration board 107. The DC configuration board can allow the individual outputs of the AC power supplies to be wired in parallel or to remain separate. In an embodiment, the default configuration can be parallel. In the event the outputs of the AC power supplies are kept separate, each AC power supply output can be connected to separate items of the ARCS-IDS, in order to disperse the power load evenly across the various other components of the system. In an embodiment, the DC configuration board can output to a low voltage terminal strip 108 and a high voltage terminal strip 109. The low voltage strip 108 can have a lower voltage relative to the high voltage terminal strip 109. In an embodiment, the high voltage strip 109 can output a voltage of 24 volts, while the low voltage strip can output a lower voltage of 13.8 volts. The actual voltages can vary depending on the current load needed by the various components of the system. In an embodiment, the low voltage terminal strip 108 can provide power to the audio circuits 200 of the ARCS-IDS, while the high voltage terminal strip 109 can provide power to the programmable logic circuit 213, as well as the various switches and lights 110 used by the ARCS-IDS.

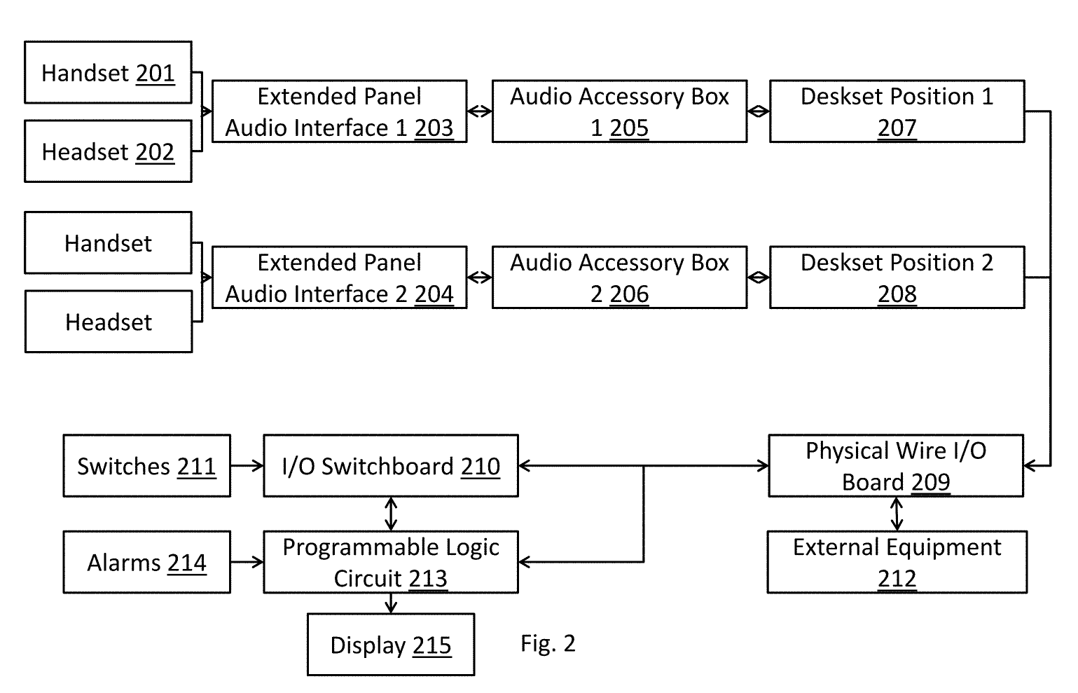

FIG. 2 depicts a block diagram of the audio and control circuitry of an Auxiliary Radio Communications System with Integrated Dispatch Console (ARCS-IDS), according to embodiments described herein. The ARCS-IDS can have one or more optional extended panel audio interfaces, into which one or more handsets 201 or headsets 202 can be connected. In an embodiment, the ARCS-IDS can have a first extended panel audio interface 203, and a second extended panel audio interface 204. These panels can include a circuit board that can extend the connectors of their respective audio accessory boxes, and can be internally mounted. The circuit boards of the extended panel audio interfaces can provide additional options not provided by the standard audio accessory box (such as selective muting), and can provide alarm output.

The ARCS-IDS can have one or more audio accessory boxes, which can provide audio interfacing capabilities to the desksets such that various handsets 201 and/or headsets 202 can be used. The audio accessory boxes can provide plain old telephone service (POTS) interfaces, as well as current telephony communication connections. In an embodiment, one or more audio accessory boxes can be used, and can additionally be connected to their respective extended panel audio interfaces. As shown in FIG. 2, the first extended panel audio interface 203 can connect to the first audio accessory box 205, while the second extended panel audio interface 204 can connect to the second audio accessory box 206.

The main audio components of the ARCS-IDS can be the one or more deskset positions. In an embodiment, the ARCS-IDS can have a first deskset position 207, which can be connected to the first audio accessory box 205, as well as a second deskset position 208, which can be connected to the second audio accessory box 206. The deskset positions can be wireline remotes which can be used to receive and transmit to the base stations as described further herein. In turn the deskset positions can be connected to the physical wire (PW) input/output (I/O) board 209. The PW I/O board 209 can be the interface board between the ARCS-IDS and the external equipment 212 of the general fire communication system. The PW I/O board 209 can provide for the actual physical wire line switching, as well as inhibition control of the one or more base stations connected to the ARCS-IDS.

The PW I/O board 209 can be connected to both an input/output (I/O) switchboard 210, as well as a programmable logic circuit (PLC) 213. The I/O switchboard 210 and PLC 213 can be used to monitor all aspects of the ARCS-IDS, including the switches (key, panel, button, or other) 211, buttons, and panel lights. The PLC can be responsible for managing one or more alarms 214, such as alarms based on battery level, lack of AC power, or failure of communication circuitry. In the presence of redundant radio equipment, the PLC can monitor and switch based on the logic programmed. In an embodiment, the ARCS-IDS can be mounted in a desk, on a wall, or in a rack enclosure. While the form factor may change based on the mounting type, the internal electronics can remain constant. One or more displays 215 can be connected to the PLC 213 in order to provide information about the system, including the communication channels being used and charge level of the batteries.

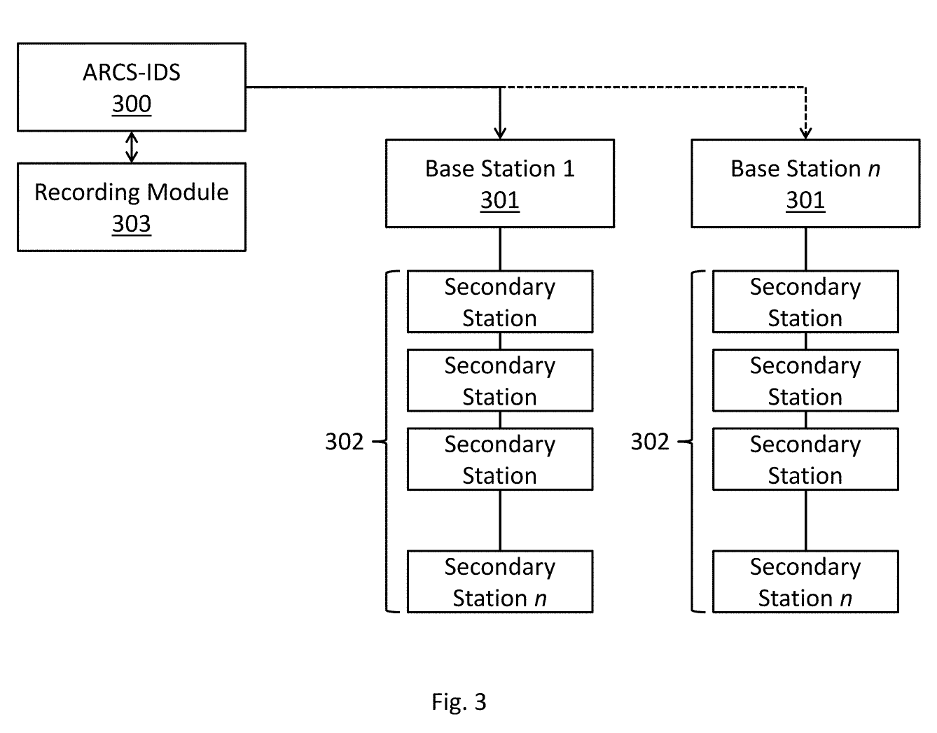

FIG. 3 depicts the connectional functionality of an Auxiliary Radio Communications System with Integrated Dispatch Console (ARCS-IDS) when incorporated into a general emergency communication system, in accordance with embodiments described herein. In an embodiment, the ARCS-IDS 300 can have the ability to independently control one or more base stations 301, where each base station can include its own independent set of secondary stations 302, which can be used to relay communication from the base station 301 to one or more locations inside a building or spread over a general area. The secondary stations 302 can be handheld units or secondary units mounted to another part of the building or coverage area.

In an embodiment, the base stations 301 can be interconnected, or can serve as redundant base stations. The base stations 301 may be located in one or more buildings. The ARCS-IDS 300 can combine both repeater and simplex HT-channels into the single console for intercommunication between systems that may use different communication protocols. The ARCS-IDS 300 can have multiple repeater channels, multiple simplex channels, or a combination of both. The ARCS-IDS 300 can communicate with the base stations using physical wiring, VOIP, radio, cellular, or other known communication methods. In an embodiment, the ARCS-IDS 300 can have a recording module 303, which can be used to record and playback a predetermined amount of messages passing through the base stations 301 into the ARC-IDS 300. The ARCS-IDS can, at the discretion of the user, communicate to a single base station 301, group of base stations 301, or simultaneously transmit to all base stations concurrently. In an embodiment, the ARCS-IDS can receive from a single base station 301, group of base stations 301, or from all base stations concurrently. The ARCS-IDS can route communications for different base stations 301 to different desksets or to peripheral audio equipment connected to the audio accessory boxes or extended panel audio interfaces.

In an embodiment with redundant base stations 301, in the event of a failure of a base station 301, the PLC of the ARCS-IDS 300 can automatically provide a failover between the failed base station and the working base station for all frequencies that are attached to the ARCS-IDS. Additionally, the ARCS-IDS 300 can be manually switched between main and alternate base stations 301 for each frequency attached to the ARCS-IDS. The ARCS-IDS can connect using the Contact Closure protocol or other known connection protocols in larger fire command stations or fire communication systems. The ARCS-IDS can communicate using VHF, RF, or can connect to any known channel used by EMS or other first responders. In an embodiment, the ARCS-IDS 300 can additionally communicate with other systems contained in a building, such as a sprinkler control system, general alarm control, elevator control, or general security system.

The Auxiliary Radio Communications System with Integrated Dispatch Console (ARCS-IDS) can be a communication console consisting of dual wireline deskset remote controls for multiple simultaneous users within an office, residential, commercial, or mixed use structure. In addition, connectors can be provided to add additional remote desksets (without the need to add additional consoles) in other locations. The desksets can be independently capable of using different radio base stations, which are each capable of multiple channels. Each ARCS-IDC console also can contain a Programmable Logic Computer (PLC), which can be used to monitor failures to the overall building communication system including base stations 301, Distributed Antenna Systems (DAS), UPS's, as well as internal power supplies and other circuitry. Each ARCS-IDC console can also provide the option of a single or dual built-in uninterruptible power supply (UPS) with dual external battery connectors with the battery state monitored by the PLC. The dual UPS can be configured to be fed by a single AC power circuit or by multiple individual power circuits.

The console can be normally in a standby state until a front panel key-switch is enabled using a key specific to a local fire department, such as the FDNY 2642 or 1620 key used in New York City. A key-switch can be provided for each repeater channel and a single key-switch for any and all Handie-Talkie (HT) channels can be included in the system design. The PLC can provide monitoring of the base stations 301 and directly connected ancillary equipment such as combiners and multi-couplers and can provide automatic switching to an alternate base station 301 if incorporated in the building design. If the DAS has redundancy, then the PLC can include the DAS redundancy in its switching logic. The automatic switching functionality can be switched off on the front panel for manual control if needed via a front panel switch which can then allow for manual switching between a main and alternate base station 301 directly using other front panel switches 211.

A fire panel alarm output (dry-contact) 214 can be provided as an additional alarm notification system. Additional internal accessories can include a connector for external telephone service line communication, choice of handset or headset use and a recording module allowing for instant recall recordings. Also available can be an Operational Safety (OS) addition which can allow the operator to transmit on all channels simultaneously for evacuation. If the building has other user radio systems this option can be made available to them as well.

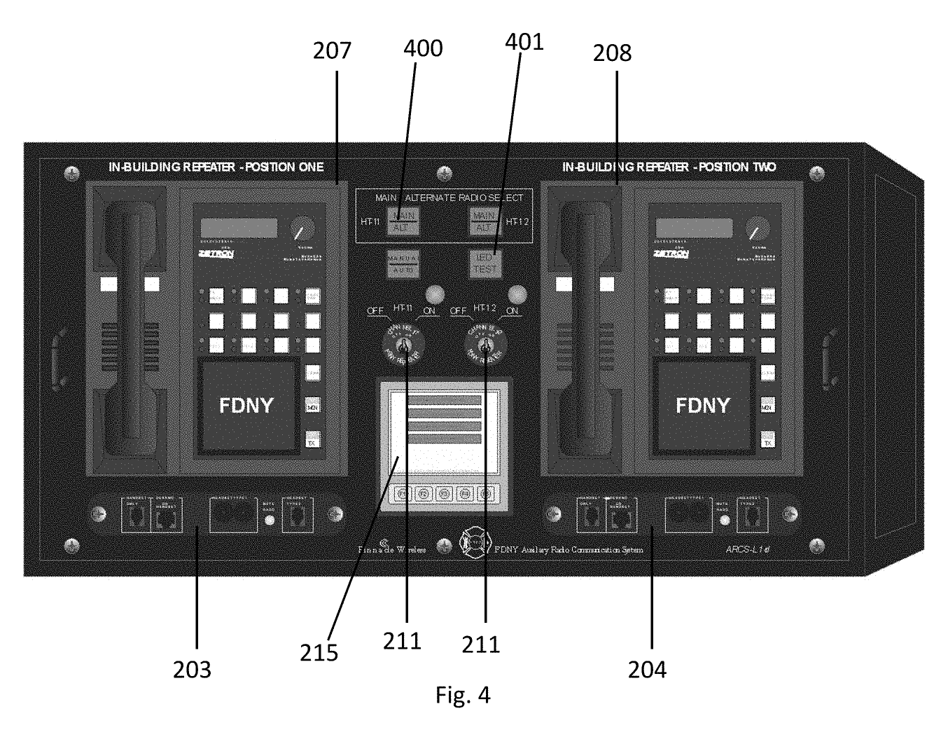

FIG. 4 illustrates a desk-based Auxiliary Radio Communications System with Integrated Dispatch Console (ARCS-IDS), according to embodiments described herein. In an embodiment, the desk-based version of the ARCS-IDS can place both the first deskset 207 and the second deskset 208 such that both face the user. Key-switches 211 can be used to activate or deactivate the desksets. The first extended panel audio interface 203 can be located below the first deskset 207, while the second extended panel audio interface 204 can be located below the second deskset 208. A display 215 can be centered between the first deskset 207 and the second deskset 208 in order to provide information about the ARCS-IDS to the user. Selector buttons 400 can be used to toggle between main or alternate radio selections. An LED test button 401 can be used to ensure that all display lights are functioning. In an embodiment, depressing the LED test button can activate all lights and/or lighted buttons on the ARCS-IDS. Releasing pressure on the LED test button 401 can then extinguish all lights and/or lighted buttons on the ARCS-IDS.

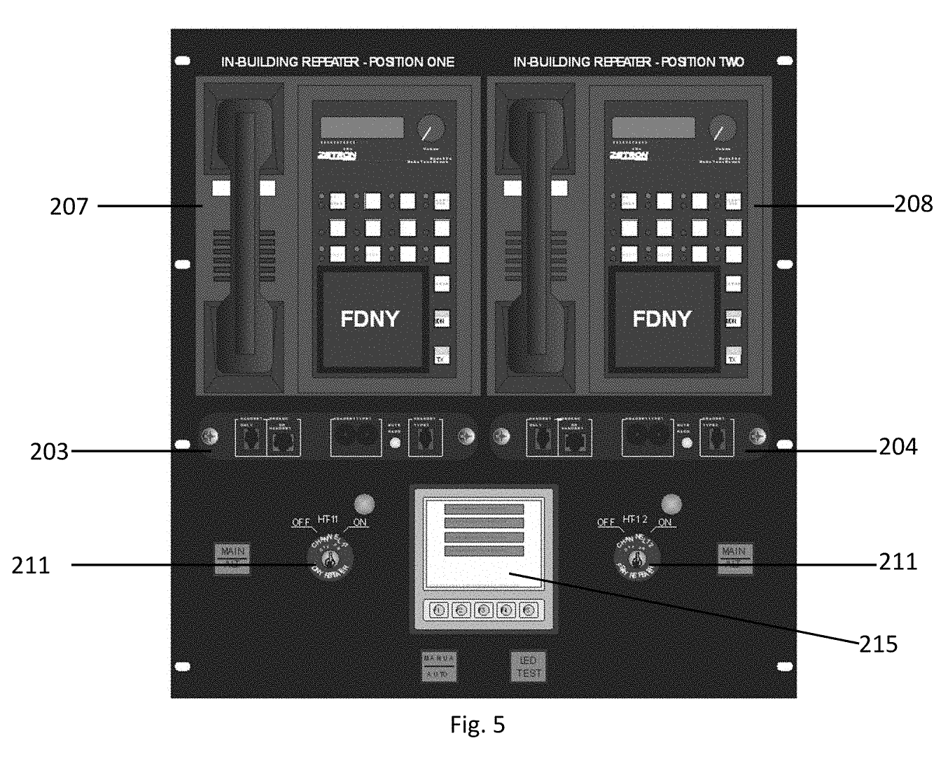

FIG. 5 illustrates a wall-mounted Auxiliary Radio Communications System with Integrated Dispatch Console (ARCS-IDS), according to embodiments described herein. A wall-mounted ARCS-IDS can have substantially the same placement of components as a desk-based ARCS-IDS. In an embodiment, the wall-mounted version of the ARCS-IDS can place both the first deskset 207 and the second deskset 208 such that both face the user. Key-switches 211 can be used to activate or deactivate the desksets, and can be placed below the extended panel audio interfaces. The first extended panel audio interface 203 can be located below the first deskset 207, while the second extended panel audio interface 204 can be located below the second deskset 208. A display 215 can be centrally located below the first deskset 207 and the second deskset 208 in order to provide information about the ARCS-IDS to the user.

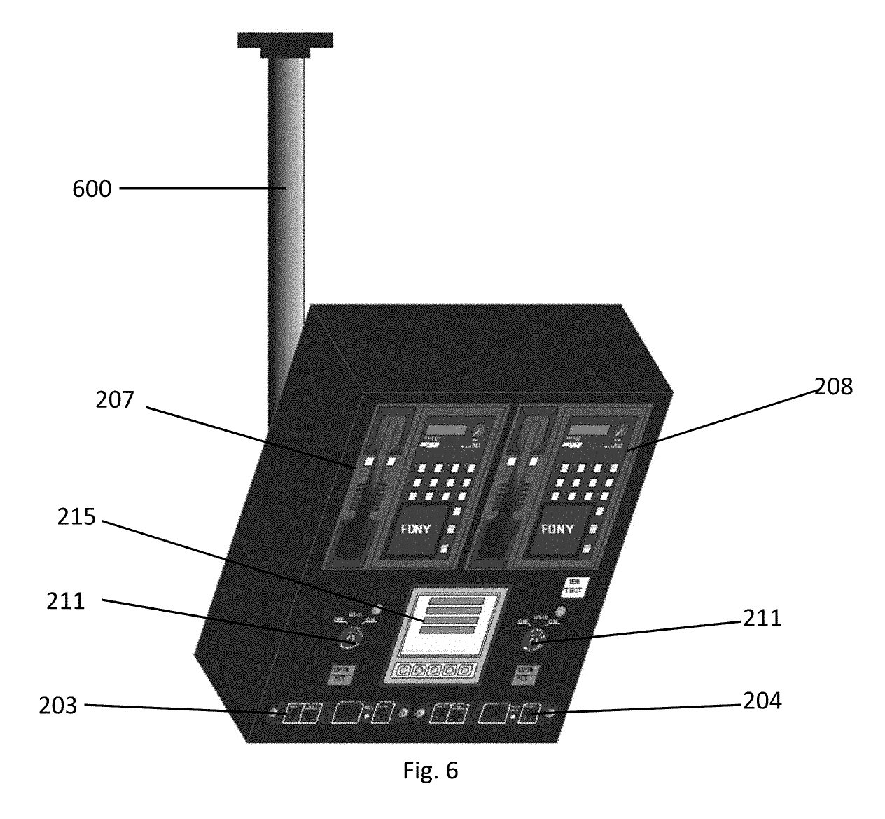

FIG. 6 illustrates a ceiling-mounted Auxiliary Radio Communications System with Integrated Dispatch Console (ARCS-IDS), according to embodiments described herein. A ceiling-mounted ARCS-IDS can have substantially the same placement of components as a desk-based ARCS-IDS, but can be suspended in the air through the use of a ceiling mount 600. In an embodiment, the ceiling-mounted version of the ARCS-IDS can place both the first deskset 207 and the second deskset 208 such that both face the user. Key-switches 211 can be used to activate or deactivate the desksets, and can be placed below the extended panel audio interfaces. The first extended panel audio interface 203 can be located below the first deskset 207, while the second extended panel audio interface 204 can be located below the second deskset 208. In an embodiment, the first and second extended panel audio interfaces can be located below the key-switches. A display 215 can be centrally located below the first deskset 207 and the second deskset 208 in order to provide information about the ARCS-IDS to the user.

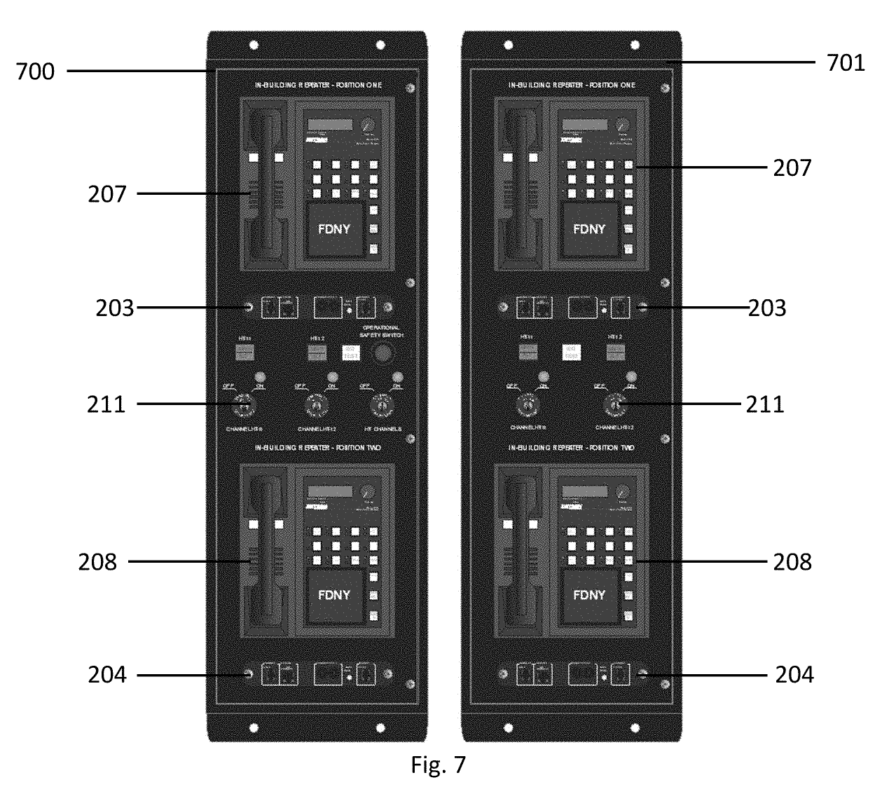

FIG. 7 illustrates two wall-mounted Auxiliary Radio Communications Systems with Integrated Dispatch Console (ARCS-IDS), according to embodiments described herein. In an embodiment, the first ARCS-IDS 700 can have the first deskset 207, first extended panel audio interface 203, and key-switches 211 located above the second deskset 208 and second extended panel audio interface 204. The extended panel audio interfaces can be located below their respective desksets. In an embodiment, a display can be absent. The second ARCS-IDS 701 can be mounted next to the first ARCS-IDS 700, and the configuration of the components of the second ARCS-IDS 701 can be substantially similar to the placement on the first ARCS-IDS 700. In an embodiment, the configuration of the components of the second ARCS-IDS 701 can be different from those of the first ARCS-IDS 700, depending on the needs of the users of the system. A key-switch or push button can be used to switch between, or concurrently use, the first ARCS-IDS 700 and the second ARCS-IDS 701.

The system and processes of the figures are not exclusive. Other systems, processes, and menus may be derived in accordance with the principles of embodiments described herein to accomplish the same objectives. It is to be understood that the embodiments and variations shown and described herein are for illustration purposes only. Modifications to the current design may be implemented by those skilled in the art, without departing from the scope of the embodiments. As described herein, the various systems, subsystems, agents, managers, and processes can be implemented using hardware components, software components, and/or combinations thereof. No claim element herein is to be construed under the provisions of 35 U.S.C. 112, sixth paragraph, unless the element is expressly recited using the phrase “means for.”

The present description and claims may make use of the terms “a,” “at least one of,” and “one or more of,” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within in the scope of the description and claims.

In addition, it should be appreciated that the foregoing description uses a plurality of various examples for various elements of the illustrative embodiments to further illustrate example implementations of the illustrative embodiments and to aid in the understanding of the mechanisms of the illustrative embodiments. These examples are intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the example provided herein without departing from the spirit and scope of the present invention.

Although the invention has been described with reference to exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. An auxiliary radio communications system with an integrated dispatch console, comprising:
at least one deskset;
at least one AC power supply, wherein the AC power supply supplies power to the at least one deskset and at least one battery backup;
a physical wire input/output board connected to at least one base station; and
a programmable logic circuit, wherein the programmable logic circuit controls the interaction of the deskset and the physical wire input/output board.

2. The system as recited in claim 1, further comprising:
at least one audio accessory box capable of telephony communication connection.

3. The system as recited in claim 2, wherein the audio accessory box provides a plain old telephone service connection.

4. The system as recited in claim 2, further comprising:
at least one extended panel audio interface connected to each audio accessory box.

5. The system as recited in claim 4, wherein each extended panel audio interface has at least one additional communication device attached.

6. The system as recited in claim 1, further comprising:
a distributed antenna system to communicate with the base stations using at least one wireless communication protocol.

7. The system as recited in claim 1, wherein the programmable logic circuit is configured to activate an alarm in the event the battery backup is low.

8. The system as recited in claim 1, further comprising:
one or more key switches to control functionality of the integrated dispatch console.

9. The system as recited in claim 1, further comprising:
at least one DC/DC converter connected to each AC power supply.

10. The system as recited in claim 1, wherein the at least one AC power supply derives power from a plurality of AC circuits.

11. An auxiliary radio communications system with an integrated dispatch console, comprising:
a first deskset;
a second deskset;
a first AC power supply connected to a first battery backup;
a second AC power supply connected to a second battery backup;
a physical wire input/output board connected to at least one base station; and
a programmable logic circuit, wherein the programmable logic circuit controls the interaction of the desksets and the physical wire input/output board.

12. The system as recited in claim 11, further comprising:
a first audio accessory box connected to the first deskset; and
a second audio accessory box connected to the second deskset;
wherein each audio accessory box is capable of telephony communication connection.

13. The system as recited in claim 12, wherein each audio accessory box provides a plain old telephone service connection.

14. The system as recited in claim 12, further comprising:
a first extended panel audio interface connected to the first audio accessory box; and
a second extended panel audio interface connected to the second audio accessory box.

15. The system as recited in claim 14, wherein each extended panel audio interface has at least one additional communication device attached.

16. The system as recited in claim 11, further comprising:
a distributed antenna system to communicate with the base stations using at least one wireless communication protocol.

17. The system as recited in claim 1, further comprising:
one or more key switches;
wherein the one or more key switches control whether the first or the second deskset is used and to what base station the deskset connects.

18. The system as recited in claim 1, further comprising:
a first DC/DC converter connected to the first AC power supply; and
a second DC/DC converter connected to the second AC power supply.

19. The system as recited in claim 1, wherein the first AC power supply derives power from a first AC circuit; and
the second AC power supply derives power from a second AC circuit.

20. An auxiliary radio communications system, comprising:
at least one base station; and
an integrated dispatch console, comprising:
at least one deskset;
a recording module configured to record communications passing through the at least one deskset;
at least one AC power supply, wherein the AC power supply supplies power to the at least one deskset and at least one battery backup;
a physical wire input/output board connected to the at least one base station; and
a programmable logic circuit, wherein the programmable logic circuit controls the interaction of the deskset and the physical wire input/output board; and
wherein the programmable logic circuit controls one or more alarms.
